(19) United States
(12) Patent Application Publication
(10) Pub. No.: US 2010/0117354 A1
(43) Pub. Date: May 13, 2010

(54) Quick connect port

(76) Inventors: Neal Keefer, Portland, OR (US); Evan Waymire, Oregon City, OR (US); Kenneth Watson, Vancouver, WA (US); John Loffink, Boring, OR (US)

Correspondence Address: Ingrid McTaggart, 3021 S.E. 56th Ave., Portland, OR, 97206, US

(21) Appl. No.: 12/590,428

(22) Filed: Nov. 6, 2009

Related U.S. Application Data
(60) Provisional application No. 61/198,689, filed on Nov. 7, 2008.

(51) Int. Cl. F16L 39/02; B23P 11/00

(52) U.S. Cl. 285/124.2; 29/428

(57) ABSTRACT

A fuel delivery system, comprising a flange, a fuel draw tube secured to the flange, the fuel draw tube including an end region extending upwardly above a first surface of the flange, the end region including a connector receiving surface, and a fuel return tube secured to the flange, the fuel return tube including an end region extending upwardly above the first surface of the flange, the end region including a connector receiving surface, wherein the connector receiving surfaces are chosen from the group consisting of a downwardly facing shoulder and an enlarged inner tube diameter.

This application claims priority on U.S. provisional patent application No. 61/198,689, filed on Nov. 7, 2008, and entitled Quick Connect Port.

### BACKGROUND OF THE INVENTION

Fuel tanks may include a fuel supply line inside the tank for supplying fuel to an engine, and a fuel return line inside the tank for returning unused fuel from the engine to the fuel tank. A fuel supply line from the tank to the engine, and a fuel return line from the engine to the tank are connected to the lines within the tank at a flange mounted on the fuel tank wall. It may be desirable to provide for connection of the exterior fuel lines at the flange of the tank in a quick and cost effective manner.

### SUMMARY OF THE INVENTION

The present invention provides a quick connect port at the fuel tank flange which allows quick connection of fuel lines while reducing the manufacturing time and costs of the flange.

### BRIEF DESCRIPTION OF THE DRAWINGS

FIG. 1 is a side cross sectional view of a die positioned over a fuel line tube.

FIG. 2 is a side cross sectional view of a die positioned in a fuel line tube and forming a quick connect port.

FIG. 3 is a side cross sectional view of a quick connect port formed in a fuel line tube.

FIG. 4 is a side cross sectional view of a die positioned over a fuel line tube.

FIG. 5 is a side cross sectional view of a die positioned in a fuel tube line and forming a connector surface to receive a quick connect cartridge fitting.

FIG. 6 is a side cross sectional view of a quick connect cartridge fitting positioned above the formed connector surface in the fuel line tube.

FIG. 7 is a side cross sectional view of a quick connect cartridge fitting pressed into the formed connector surface in the fuel line tube.

FIG. 8 is a schematic view of a fuel tank system including a fuel draw line and a fuel return line connecting a fuel tank and an engine.

### DETAILED DESCRIPTION OF THE DRAWINGS

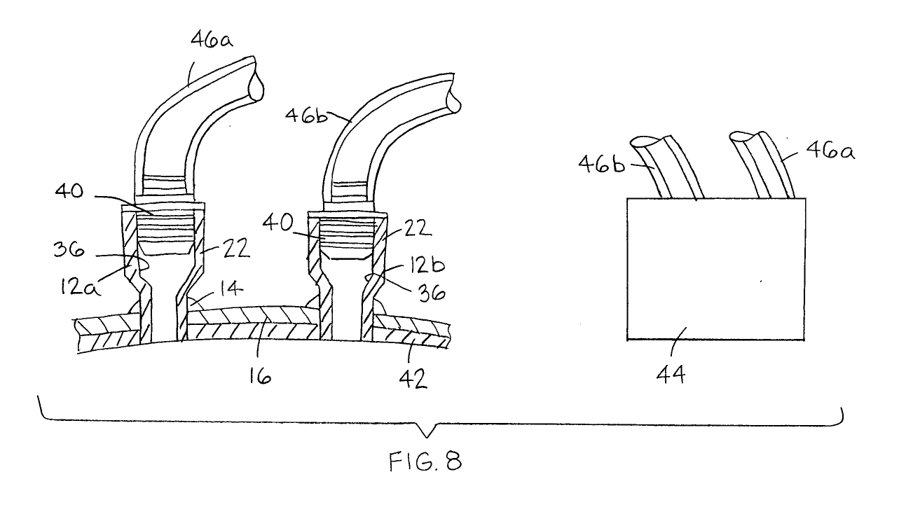

FIG. 1 is a side cross sectional view of a die 10 positioned over a fuel line tube 12. Tube 12 may be a fuel draw line or a fuel return line that is welded at a weld 14 to a substrate, such as a flange 16, also referred to as an adapter plate. In other embodiments, substrate 16 may be a fuel shutoff valve body or a fuel tee body. Tube 12 may be an extruded tube having an inner diameter 18 that is uniform along a length of tube 12. Flange 16 may be secured to the wall of a fuel tank (see FIG. 8) so as to secure a lower, or second end region, 20 of tube 12 within an interior of a fuel tank. An upper region 22, also referred to as a first end region, of tube 12 extends above flange 16 and is subject to a forming operation by die 10, as will be described below.

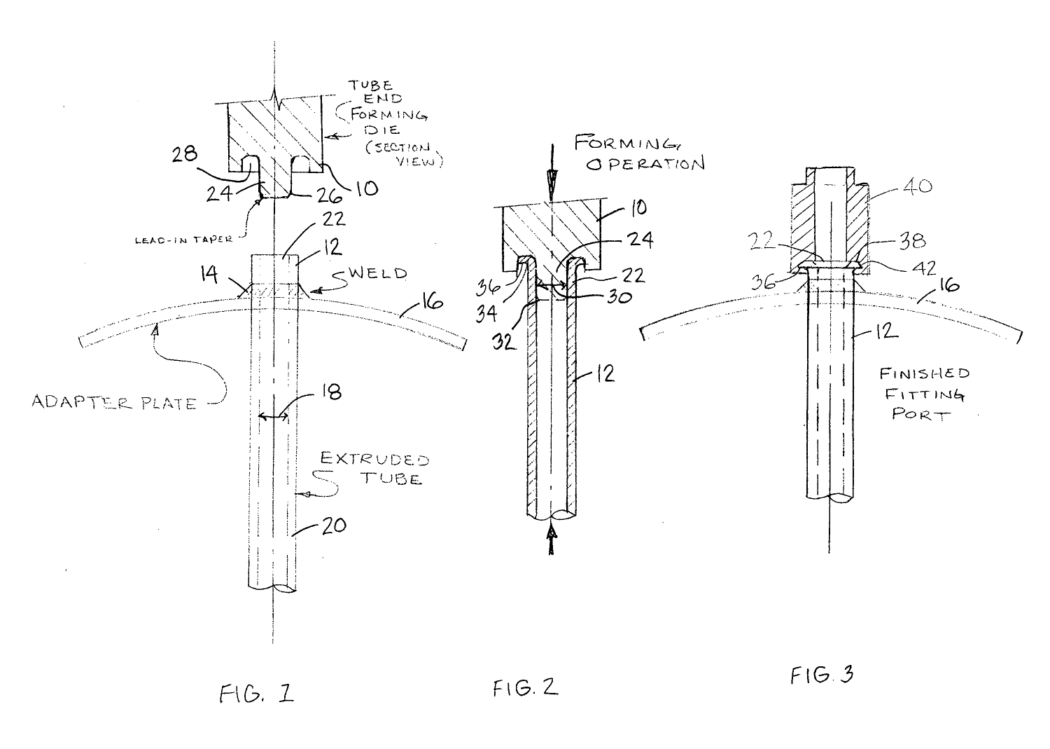

Die 10 is a tube end forming die that includes a central protrusion 24 which may include a lead-in taper 26 around an outer edge thereof. Die 10 may further include a recess, such as a circular shaped recess 28 that encircles protrusion 24. Recess 28 may define a concave curve so as to bend an end 22 of tube 12 into a curled end region (see FIG. 3) to define a connect port 38, of tube 12 (see FIG. 3). In one embodiment die 10 and tube 12 may both be manufactured of steel. In other embodiments, other durable materials may be utilized.

FIG. 2 is a side cross sectional view of die 10 positioned in fuel line tube 12 and forming a quick connect port, such as a connector surface 38, with flange 16 shown removed for ease of illustration. During forming of end 22 of tube 12, die 10 is brought into engagement with tube 12 in a “cold working” process. In particular, in the embodiment shown, protrusion 24 of die 10 is forced downwardly into an interior of end region 22 of tube 12. If protrusion 24 defines an outside diameter 30 that is slightly larger than inside diameter 18 of tube 12, the inner diameter of tube 12 in end region 22 will be slightly enlarged by die 10 and may form a shelf 32 where the slightly enlarger inner diameter of end region 22 of tube 12 meets with the original inner diameter 18 of tube 12. Die 10 is moved downwardly onto tube 12 such that the end of region 22 of tube 12 is curled backwardly upon itself within circular shaped recess 28 of die 10 to form a curved end 34 of tube 12. Curved end 34 of tube 12 may define a downwardly extending lip 36, also referred to as a latch, a connector surface, or a connection surface 36, that may allow quick connection of a connector (see FIG. 6) thereto.

FIG. 3 is a side cross sectional view of a quick connect port 38 formed in a fuel line tube. After formation of curved end 34 of tube 12, including downwardly extending lip 36, die 10 may be moved upwardly and away from tube 12 such that end region 22 of tube 12, including curved end 34, may define the quick connect port 38 of tube 12. After formation of connector surface 36, a connector 40, such as a cartridge, may be secured on connector surface 36. In the embodiment shown, connector 40 may be a “snap-fit” cartridge that is press fit onto connector surface 36 such that downwardly extending lip or shoulder 36 retains the connector 40 in place on tube 12. In particular, an upwardly facing shoulder 42 of connector 40 may be secured by downwardly facing shoulder 36 of connector port 38 to retain connector 40 on tube 12.

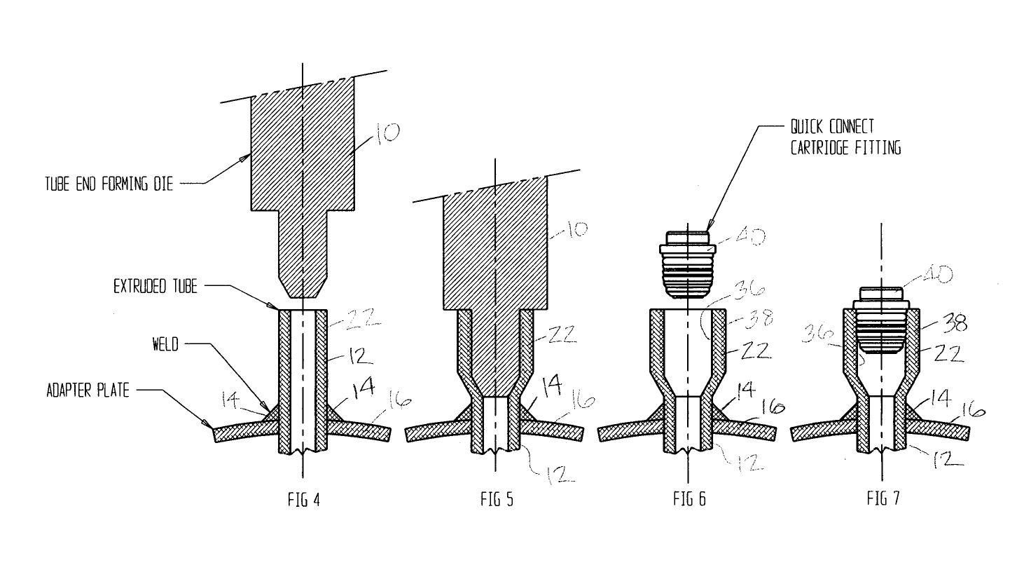

FIG. 4 shows another embodiment of the quick connect port system. In this embodiment, the fuel line tubing 12 passes through an adapter plate 16 and is welded at a weld 14 to the adapter plate 16.

FIG. 5 shows that the first end region 22 of the fuel line tube 12 is formed by a tube end forming die 10 to form a close tolerance receptacle or connect port 38 in the tube end suitable for receiving a quick connect cartridge fitting 40.

FIGS. 6 and 7 show a quick connect cartridge fitting 40 is pressed into the tube end receptacle 38 where the connector 40 is retained by an interference fit with the close tolerance connector surface 36.

FIG. 8 is a schematic view of a fuel tank system including a fuel draw line 46a and a fuel return line 46b connecting a fuel tank 42 and an engine 44, wherein the fuel lines 46a and 46b are each connected to fuel tank 42 and fuel draw and return tubes 12a and 12b, at flange 16 by connectors 40a and 40b, received within connector ports 38a and 38b, respectively.

In one embodiment, the quick connect port is integrated into a fuel tank draw and return tube system. In other embodiments, the quick connect port may be utilized in a fuel shutoff valve used on a fuel tank or a fuel tee positioned on a fuel tank. Accordingly, the quick connect port may be described generally as utilized in a fuel system and allowing quick connection of a fuel tube to a connector within a fuel delivery system.

The above described structures and methods have many advantages over prior art structures and methods, which may include securing of adaptors to an end of a fuel line tube. Use of die 10 to form a quick connect port integral to tube 12, instead of attaching an adaptor to an end of tube 12, reduces the manufacturing costs of the device and the time of the manufacturing process because an adaptor is not required to be separately formed, secured to the tube and then inspected to ensure a proper attachment. Moreover, forming the quick connect port integral to tube 12 reduces the misattachment, misalignment and leakage problems of the adaptors of the prior art.

We claim:

1. A fuel delivery system, comprising:
a flange;
a fuel draw tube secured to said flange, said fuel draw tube including an end region extending upwardly above a first surface of said flange, said end region including a connector receiving surface; and
a fuel return tube secured to said flange, said fuel return tube including an end to region extending upwardly above said first surface of said flange, said end region including a connector receiving surface;
wherein said connector receiving surfaces are chosen from the group consisting of a downwardly facing shoulder and an enlarged inner tube diameter.

2. The system of claim 1 wherein said downwardly facing shoulder is chosen from one of a downwardly facing shoulder positioned in an interior of said first end region and a downwardly facing shoulder positioned on an exterior of said first end region.

3. The system of claim 1 wherein said flange includes a first aperture extending therethrough and a second aperture extending therethrough, and wherein said fuel draw tube is secured within said first aperture and said fuel return tube is secured within said second aperture.

4. The system of claim 1 wherein said fuel draw tube is welded to said flange and said fuel return tube is welded to said flange.

5. The system of claim 1 wherein said flange includes a second surface shaped to conform to an exterior surface of a fuel tank, wherein a second end region of said fuel draw tube and a second end region of said fuel return tube extend outwardly from said second surface of said flange.

6. The system of claim 1 further comprising a first connector secured on said connector receiving surface of said fuel draw tube and a second connector secured on said connector receiving surface of said fuel return tube, said first connector connected to a tube extending to an engine fuel inlet, and said second connector connected to a tube extending to an engine fuel outlet.

7. A method of manufacturing a fuel delivery system, comprising:
providing a substrate including an aperture extending therethrough;
placing a fuel tube through said aperture in said substrate such that a first end region of said fuel tube extends through said aperture and outwardly of said substrate;
securing said fuel tube to said substrate; and
contacting said first end region of said fuel tube with a fuel tube forming die to form in said first end region of said fuel tube a connector surface adapted to secure a connector thereto.

8. The method of claim 7 wherein said connector surface is chosen from one of a downwardly facing shoulder positioned in an interior of said first end region, a downwardly facing shoulder positioned on an exterior of said first end region, and an enlarged inner tube diameter in said first end region.

9. The method of claim 7 further comprising:
placing a second fuel tube through a second aperture in said substrate such that a first end region of said second fuel tube extends through said second aperture and outwardly of said substrate;
welding said second fuel tube to said substrate; and
contacting said first end region of said second fuel tube with a fuel tube forming die to form in said first end region of said second fuel tube a connector surface adapted to secure a connector thereto.

10. The method of claim 9 wherein said fuel tube is a fuel draw tube and said second fuel tube is a fuel return tube.

11. The method of claim 7 wherein said fuel tube is welded to said substrate.

12. The method of claim 10 further comprising connecting said fuel draw tube to a connector connected to a tube extending to an engine fuel inlet, and connecting said fuel return tube to a connector connected to a tube extending to an engine fuel outlet.

13. The method of claim 7 wherein said fuel tube forming die bends said first end region into a curled end region that defines a downwardly extending shoulder on an exterior surface of said first end region, said downwardly extending shoulder adapted to secure said connector thereon.

14. The method of claim 7 wherein said fuel tube forming die enlarges said first end region into an enlarged inner diameter region that defines an inner surface sized to frictionally secure a connector therein.

15. The method of claim 7 wherein said substrate is secured in a stationary position and wherein said die is moved toward and into contact with said first end region of said fuel tube.

16. The method of claim 7 wherein said connector is a cartridge fitting and said substrate is chosen from one of a flange, a fuel shutoff valve body, and a fuel tee body.

17. A method of connecting fuel lines, comprising:
providing a substrate including a first aperture extending therethrough and a second aperture extending therethrough;
placing a first fuel tube through said first aperture in said substrate such that a first end region of said first fuel tube extends through said aperture and outwardly of said substrate;
placing a second fuel tube through said second aperture in said substrate such that a first end region of said second fuel tube extends through said aperture and outwardly of said substrate;
securing said first and second fuel tubes to said substrate;
contacting said first end region of said first fuel tube with a fuel tube forming die to form in said first end region of said first fuel tube a connector surface adapted to secure a connector thereto; and
contacting said first end region of said second fuel tube with a fuel tube forming die to form in said first end region of said second fuel tube a connector surface adapted to secure a connector thereto.

18. The method of claim 17 wherein said connector surfaces are chosen from one of a downwardly facing shoulder positioned in an interior of a first end region of said first and second fuel tubes, a downwardly facing shoulder positioned on an exterior of said first end region of said first and second fuel tubes, and an enlarged inner tube diameter in said first end region of said first and second fuel tubes.

19. The method of claim 17 wherein said first fuel tube is a fuel draw tube and said second fuel tube is a fuel return tube.

20. The method of claim 19 further comprising connecting said fuel draw tube to a connector connected to a tube extending to an engine fuel inlet, and connecting said fuel return tube to a connector connected to a tube extending to an engine fuel outlet.
